(19) United States
(12) Patent Application Publication
(10) Pub. No.: US 2026/0115954 A1
(43) Pub. Date: Apr. 30, 2026

(54) APPARATUS AND METHOD FOR PROCESSING A PIPE MADE OF THERMOPLASTIC MATERIAL

(71) Applicant: SICA S.P.A., Alfonsine (RA) (IT)

(72) Inventor: Marco GULMINELLI, Ravenna (RA) (IT)

(21) Appl. No.: 18/880,707

(22) PCT Filed: Jul. 5, 2023
(86) PCT No.: PCT/IB2023/056962

§ 371 Date: Jan. 2, 2025

(30) Foreign Application Priority Data
Jul. 8, 2022 (IT) 102022000014488

(51) Int. Cl. B26D 3/16; B26D 5/00; B26D 7/10

(52) U.S. Cl. CPC B26D 3/166; B26D 3/162; B26D 5/005; B26D 7/10

(57) ABSTRACT

Described is an apparatus for processing a pipe made of thermoplastic material; each pipe extends along a longitudinal axis and has a first end and a second end; the apparatus comprises an element for chamfering a portion of the first end of the pipe the element comprising at least one processing tool having a respective processing surface; heating means associated with the processing tool are configured for heating the processing surface of the processing tool to a predetermined temperature.

### TECHNICAL FIELD

This invention relates to an apparatus and a method for processing a pipe made from thermoplastic material, in particular an apparatus and a method for performing a specific processing of an end of the pipe.

Thermoplastic pipes are typically produced by an extrusion process in a plant which expels the material in the plastic state, using a rotary screw system which forces the material through a calibrated mould of suitable shape and dimensions. The pipe production plant is known as an extrusion line and it comprises a plurality of apparatuses, each of which designed for a specific function.

In this plant there is usually a machine, generally located at the end of the line, called the cutter and configured for dividing the extruded continuous pipe into pieces of defined and predetermined length. More specifically, the machine comprises a cutting unit installed on a movable carriage which can move on request in a synchronised fashion with the extruded pipe and equipped with clamping means configured for coupling with the pipe during the cutting operation.

The pieces of pipe made from thermoplastic material produced in this way are normally used to constitute rigid pipes for sanitary purposes inside buildings, for outdoor rainwater pipes, for water distribution and drains.

In general, in order to create a conduit with an assigned total length, these pieces require, as well as cutting, also a tapering of one of the two ends of the piece.

This processing is called chamfering and has the aim of facilitating the coupling with the opposite end of an equivalent pipe, on which a specific bell-shaped widening, called the bell, has been made, for creating a continuous conduit for transporting fluids. This chamfering operation may be performed simultaneously with or after the cutting process.

For the above-mentioned types of pipes, cutting and chamfering are commonly carried out by removal of material.

A typical thermoplastic material with which the above-mentioned pipes are made is, for example, PVC-U, a material with a mechanical behaviour of the fragile type, but with a particularly high hardness.

In order to effectively chamfer the end of the pipe, the cutting machine is usually equipped with a motor-driven cutter equipped with perimeter cutters or with a surface coating of abrasive material.

As a result, the chamfering process by removal of material produces swarf and dust and generates a series of problems, including rapid wear of the processing tools and of the mechanical parts of the machine, the need for suitable systems for extracting and capturing the dust produced and, lastly, the need to collect, store and dispose of all the waste products generated by the cutting and chamfering processes.

In light of all of the above, it is increasingly important to have a method and an apparatus capable of processing, mainly chamfering, a pipe without removal of material, that is to say, without the generation of chippings and/or dust.

### BACKGROUND ART

The presence is known in the technical literature of devices which are able to chamfer pipes made of thermoplastic material without the removal of material through the use of a heating unit which, before the chamfering process, locally modifies the rheological state of the material, bringing it to a temperature so the material becomes easily deformable.

The processing without removal of material results in processing times which are slower than the processing by the removal of chippings, but in any case have undoubted advantages by resolving the various problems described.

### DISCLOSURE OF THE INVENTION

The aim of the invention is to perform a chamfering of an end of a pipe, increasing the production speed with respect to the prior art solutions.

In this technical context, the Applicant has prepared an apparatus and a method for processing a pipe made from thermoplastic material comprising the technical features described in the respective independent claims.

Advantageously, the apparatus and relative method allows chamfering of pipes made from thermoplastic material without removal of material, guaranteeing an excellent productivity.

### BRIEF DESCRIPTION OF DRAWINGS

Advantageously, the apparatus and relative method allows chamfering of pipes made from thermoplastic material without removal of material, guaranteeing an excellent productivity.

The features of the invention are clearly described in the claims below and the advantages are more apparent from the detailed description which follows, with reference to the accompanying drawings which illustrate a preferred, non-limiting example embodiment of the invention and in which:

FIG. 1 is a schematic side view of a machine which is able to cut pieces of pipe of predetermined length starting, for example, from a pipe made of thermoplastic material continuously extruded, a machine on which an apparatus according to the invention may be installed;

FIG. 2 is a schematic perspective view of a detail of the apparatus according to the invention;

FIG. 3 is a schematic perspective view of a further detail of the apparatus according to the invention;

FIG. 4 is a schematic front view of a detail of FIG. 3;

FIGS. 5A, 5B and 5C schematically illustrate a sequence of steps for processing a pipe by means of the detail illustrated in FIG. 2;

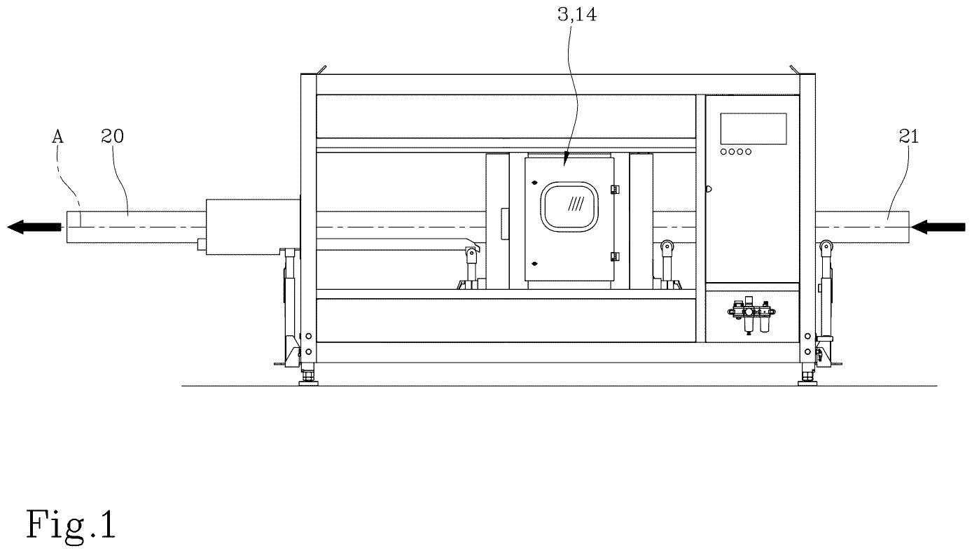

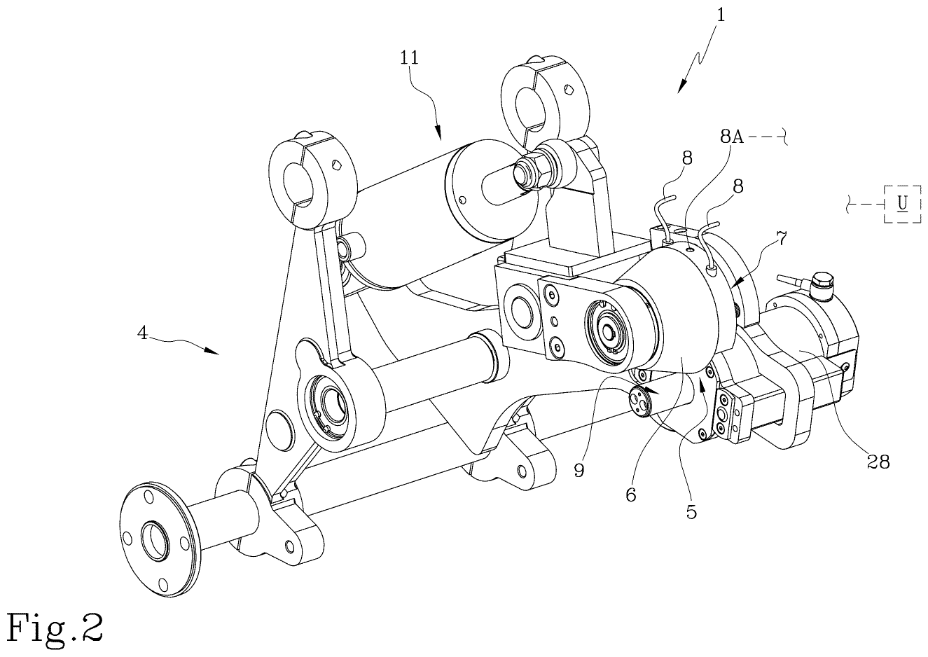

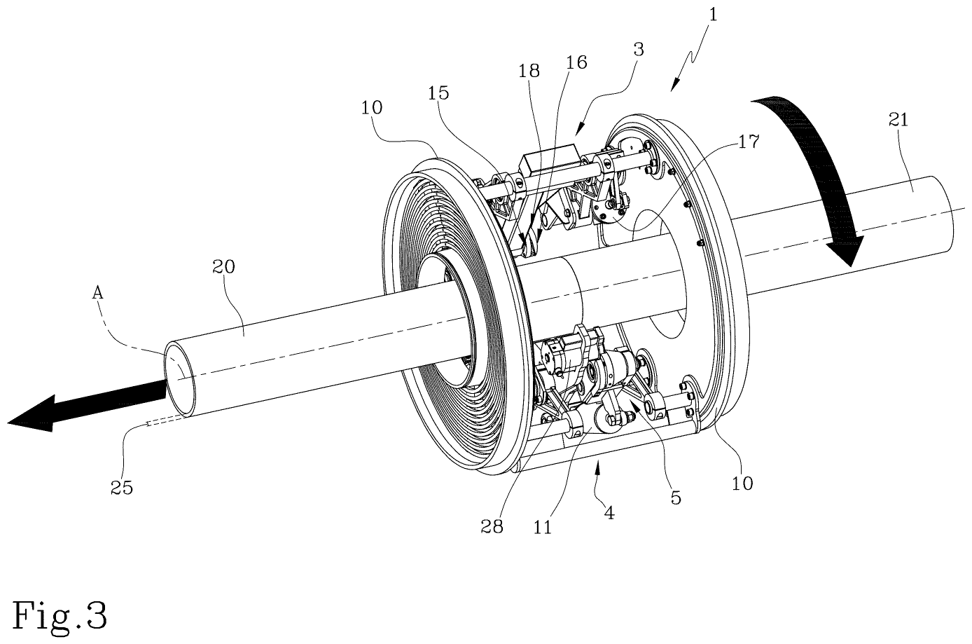

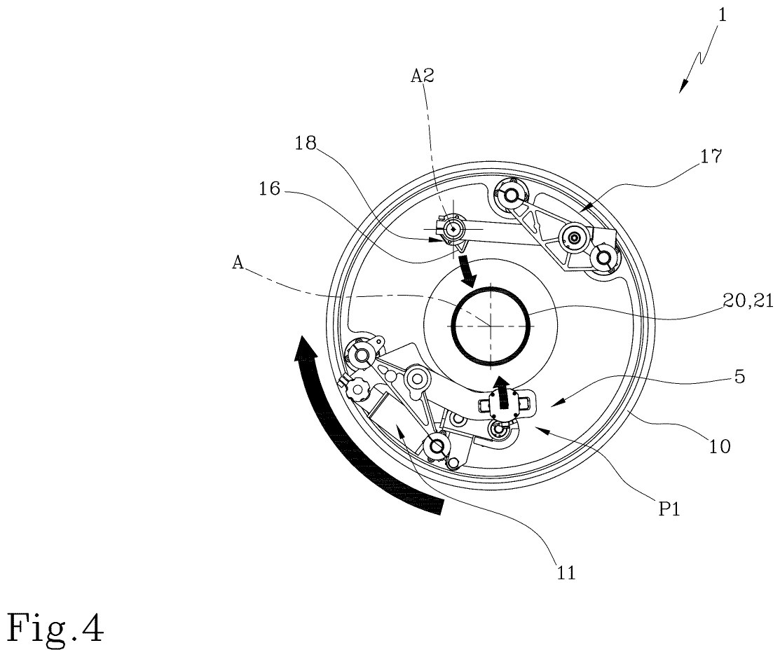

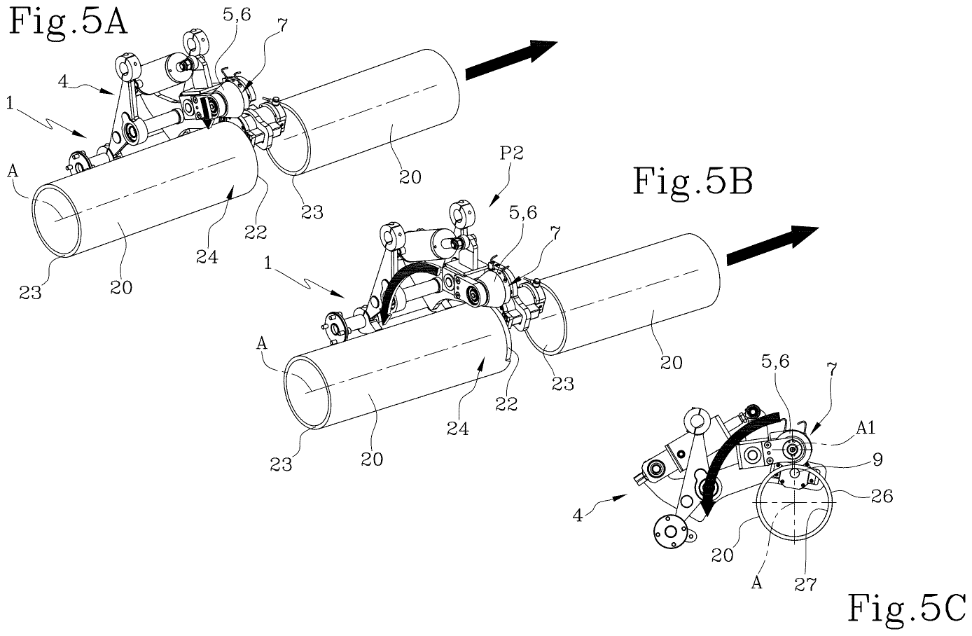

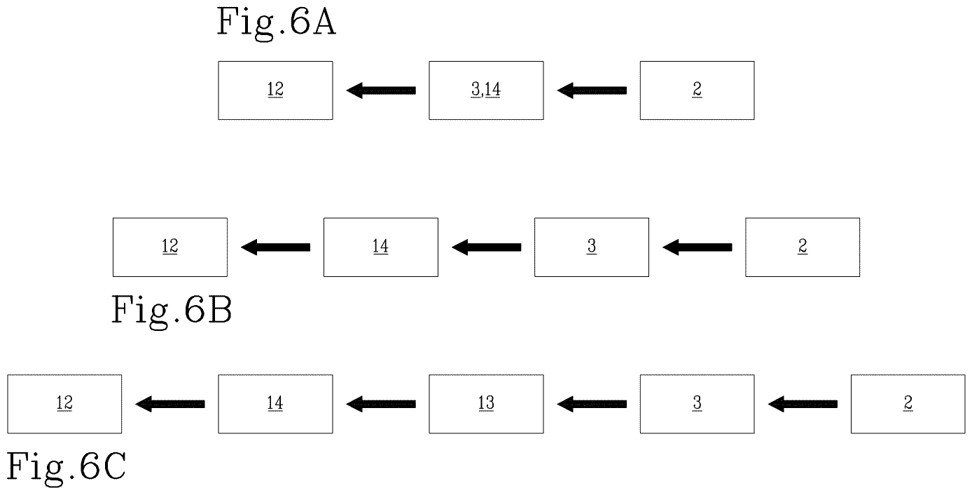

each of FIGS. 6A, 6B and 6C illustrates a schematic block diagram of the machine according to the invention according to a respective embodiment.

### DETAILED DESCRIPTION OF PREFERRED EMBODIMENTS OF THE INVENTION

With reference to the accompanying drawings, the numeral 1 denotes an apparatus for processing a pipe 20 made of thermoplastic material, in particular, for example, a pipe 20 made of PVC-U.

The reference to pipes made of thermoplastic material such as PVC-U is shown by way of example, as they are the pieces of pipes which usually require this processing and are used for making pipelines for transporting and discharging fluids of this type, but it must obviously not be considered limiting.

According to an embodiment illustrated, the apparatus 1 is preceded by a station 2 for feeding a continuous extruded pipe 21, having a longitudinal axis A parallel to the advancement direction, which is subsequently divided into individual pipes 20 as explained in more detail below. Alternatively, the feed station 2 feeds the apparatus 1 with a series of individual pipes designed to be in turn divided into pipes 20 of shorter length.

A cutting unit 3 divides the continuous extruded pipe 21 into a plurality of pipes 20 or, according to the alternative embodiment, divides the individual pipes fed into pipes 20 of shorter length.

Each pipe 20 has a first end 22 and a second end 23 and a main longitudinal axis of extension A.

According to an aspect of the invention, the cutting unit 3 comprises at least one cutting tool 16.

The apparatus 1 comprises a chamfering station 14 equipped with a chamfering element 4 designed to finalise the chamfering operations.

In particular, the apparatus 1 comprises an element 4 for chamfering a portion 24 of the first end 22 of a respective pipe 20.

More specifically, the expression “chamfering of an end” means the forming of a taper on an end of the pipe which facilitates the coupling, for example, with an end of an equivalent pipe after the latter end has undergone a specific process of widening, the so-called belling.

The chamfering element 4 comprises at least one processing tool 5 which has a processing surface 6.

According to a preferred embodiment, the chamfering element 4 comprises a contact element 9.

The contact element 9 is configured for operating in conjunction with the processing tool 5.

The processing tool 5 and the contact element 9 are configured to pass between a non-operating position P1, wherein they are not engaged with the pipe 20, and an operating position P2, wherein they make contact with a respective surface 26, 27 of the portion 24 of the first end 22 of the pipe 20.

In the non-operating position P1, the processing tool 5 and the contact element 9 are not in contact with the pipe 20.

More specifically, the contact element 9 actively participates in the chamfering together with the processing tool 5 supporting the portion of pipe subject to chamfering in such a way as to prevent the collapse.

In the operating position P2, the processing tool 5 comes into contact with the outer surface 26 of the portion 24 of the first end 22 of the pipe 20 and the contact element 9 comes into contact with the inner surface 27 of the portion 24 of the first end 22 of the pipe 20.

In particular, in the operating position P2, the processing surface 6 of the processing tool 5 comes into contact with the outer surface 26 of the portion 24 of the first end 22 of the pipe 20.

It should be noted that for the chamfering to be performed it is necessary that each pipe 20 cut by the cutting unit 3 is suitably moved away from the pipe from which it has been obtained.

For example, according to the embodiment in which the pipes 20 are obtained from cutting the continuous extruded pipe 21, specific means, not illustrated in the accompanying drawings, are configured for moving a pipe 20 away from the continuous extruded pipe 21.

According to an embodiment, the apparatus 1 comprises an element 10 for supporting the chamfering element 4.

The supporting unit 10 comprises movement means 11 configured for moving the processing tool 5 radially relative to the pipe 20 from the non-operating position P1 to the operating position P2, and vice versa.

For example, the movement means 11 comprise an actuator, for example of a hydraulic, pneumatic or electrical type, and an articulated system connected to the processing tool 5.

According to an embodiment, further movement means 28 of a, for example, hydraulic, pneumatic or electric nature are configured for moving the contact element 9 between the non-operating position and the operating position.

In other words, in the operating position P2 the processing tool 5 is forcedly pushed towards the outer surface of the portion 24 of the first end 22 of the pipe 20, whilst the contact element 9 is in a condition of contact tangential with the inner surface of the same portion 24 of the first end 22.

According to an aspect of the invention, the supporting element 10 is configured to rotate the chamfering element 4 about the axis A of the pipe 20, in particular for generating at least one complete rotation of the chamfering element 4 about the axis A of the pipe 20.

Advantageously, by means of this rotation or sequence of rotations by means of the supporting element 10, the chamfering element 4 is able to chamfer the pipe 20 over the entire circumference of the portion 24 of the first end 22 of the pipe 20.

According to the invention, the apparatus 1 comprises heating means 7, associated with the processing tool 5, configured for heating the processing surface 6 of the processing tool 5 to a predetermined temperature.

Advantageously, the processing surface 6 heated by the heating means 7, in particular when the processing tool 5 is in the operating position P2, allows the end portion of the pipe 20 to be chamfered to be heated directly during the chamfering operation.

Advantageously, heating the end portion of the pipe 20 to be chamfered directly during the chamfering operation allows a chamfering by plastic deformation of the pipe 20 and therefore without removal of material, that is to say, without the formation of chippings and dust.

In effect, a pipe 20 made from thermoplastic material, at temperatures greater than or equal to a predetermined threshold value (dependent on the nature of the material itself), modifies at least locally the relative rheological state, becoming plastic and therefore deformable.

Advantageously, heating the end portion of the pipe 20 to be chamfered directly during the chamfering operation makes it possible to speed up the chamfering operation compared with the prior art.

Speeding up the chamfering operation consequently improves the productivity of the apparatus 1.

According to a preferred embodiment, the heating means 7 make contact with at least part of the processing tool 5.

Preferably, the processing tool 5 has the shape of a truncated cone having a larger base designed to make contact with the heating means 7.

According to other embodiments not illustrated, the processing tool 5 may be, for example, cylindrical in shape and with the axis of rotation suitably inclined with respect to the axis of the pipe 20.

The truncated cone shape of the heated processing tool 5 allows the portion 24 of the first end 22 of the pipe 20 to be tapered, deforming it plastically when the processing tool 5 is in the operating position P2.

According to an aspect of the invention, the processing tool 5 is configured to rotate about a relative axis of rotation A1.

Advantageously, the rotation of the processing tool 5, when it is in the operating position P2, favours the chamfering of the portion 24.

According to a preferred embodiment, the processing surface 6 of the pipe 20 is free of cutters.

The processing surface 6 of the pipe 20 is a smooth, continuous surface without irregularities.

Advantageously, the smooth, continuous processing surface 6 without irregularities favours the plastic deformation of the pipe 20 without removal of material during the rotation of the processing tool 5 when the processing tool 5 is in the operating position P2.

According to an embodiment, the heating means 7 heat the processing tool 5 by conduction, for example as they are in constant sliding contact.

Preferably, the heating means 7 comprise a metallic body heated by means of one or more thermal resistors 8.

According to a further embodiment, the heating means 7 are of the inductive type.

According to an alternative embodiment, the heating means 7 are of the irradiated type.

According to an aspect of the invention, the apparatus 1 comprises a command and control unit U.

Preferably, the apparatus 1 comprises at least one temperature sensor 8A configured for determining a temperature value of the heating means 7 or directly of the processing surface 6.

The temperature sensor 8A is configured for sending a signal, representing the temperature value of the predetermined heating means 7 or the processing surface 6, to the command and control unit U.

The command and control unit U is configured for setting the operating temperature of the heating means 7 or of the processing surface 6 as a function of said signal.

In other words, the command and control unit U receives from the temperature sensor 8A a signal relative to the measured temperature value of the heating means 7 or directly of the processing surface 6, and on the basis of this value sets the temperature at which the heating means 7 operate.

The command and control unit U is configured for setting the operating temperature of the heating means 7, for example, controlling the activation and switching off or regulating the power.

It should be noted that, obviously, if the temperature of the processing surface 6 is not measured directly, the setting of the operating temperature of the heating means 7 as a function of the temperature of the heating means 7 indirectly also results in control of the temperature of the processing surface 6.

Keeping the heating means 7 at a predetermined temperature ensures that the processing surface 6 of the processing tool 5 is kept in a desired thermal condition during the chamfering of the pipe 20.

Preferably, the temperature sensor 8A is a thermocouple if it controls the temperature of the heating means 7 or a pyrometer if it directly controls the temperature of the processing surface 6.

According to an embodiment, the apparatus 1 comprises a station 13 for heating at least the portion 24 of the first end 22 of each pipe 20 positioned upstream of the chamfering element 4.

In other words, the apparatus 1 comprises a heating station 13 designed to heat at least the portion 24 of the first end 22 of the pipe 20 before the pipe 20 undergoes the chamfering.

Advantageously, heating both the portion 24 of the first end 22 of the pipe 20 and the processing surface 6 of the processing tool 5 makes it possible to chamfer the pipe 20 without removal of chippings faster than in the prior art, also for pipes 20 with an unreduced thickness 25 (for example greater than 5 mm).

In addition, it should be noted that it is not necessary to heat the portion 24 of the first end 22 of the pipe 20, but only the processing tool 5, if the pipe 20 is considered to have a small thickness (for example a thickness 25 less than or equal to 5 mm).

In this way, the productivity of the apparatus 1 is optimised, since the chamfering process without removal of material is speeded up (not requiring the preventive heating step or significantly reducing the time); all of this in compliance with the dimensional quality parameters of the pipes required by the corresponding regulations.

According to a preferred embodiment, the supporting element 10 comprises the cutting unit 3.

In other words, according to a preferred embodiment, the cutting unit 3 and the chamfering element 4 are included in the same processing station of the apparatus 1.

The supporting unit 10 comprises further movement means 17 configured for moving the cutting tool 16 radially relative to the pipe 20 between an operatively active position and an operatively non-active position, and vice versa.

The supporting element 10 is configured for rotating the cutting unit 3 about the axis A of the pipe 20, in particular for generating at least a complete rotation of the cutting tool 16 about the axis A of the pipe 20.

According to a preferred embodiment, the cutting tool 16 comprises a cutting knife blade 18 or a circular blade having an axis A2 and configured to rotate about its axis A2.

According to an embodiment not illustrated in the accompanying drawings, the apparatus 1 comprises a plurality of chamfering elements 4.

The supporting element 10 is configured to rotate each chamfering element 4 of the plurality of chamfering elements 4 about the axis A of the pipe 20.

In particular, the supporting element 10 is configured for rotating each of the chamfering elements 4 for a circumferential portion of the portion 24 of the first end 22 of the pipe 20 in such a way that the sum of the circumferential portions covers at least the entire circumference of the portion 24 of the first end 22 of the pipe 20.

In particular, the supporting element 10 is configured for rotating each of the chamfering elements 4 for a circumferential portion of the portion 24 of the first end 22 of the pipe 20 simultaneously.

In other words, each of the chamfering elements 4 chamfers a part of the portion 24 of the first end 22 of the pipe 20 and the sum of the lengths of the parts chamfered by each of the chamfering elements 4 corresponds at least to the total length of the circumference of the portion 24 of the first end 22 of the pipe 20.

Advantageously, rotating each chamfering element 4 for a circumferential portion of the pipe 20 in such a way that the sum of the chamfered circumferential portions correspond at least to the entire circumference of the pipe 20 allows the chamfering process to be speeded up.

In effect, rotating each chamfering element 4 simultaneously for a circumferential portion of the pipe 20 takes less time than performing a complete rotation about the pipe 20 with a single chamfering element 4.

According to an embodiment, a unit 12 for belling the second end 23 of the pipe 20 is positioned downstream of the cutting unit 3.

More specifically, the expression “belling of a pipe” means a specific bell-shaped widening of one end of the pipe.

The invention also defines a method for making a pipe 20 made of thermoplastic material, in particular PVC-U.

The method comprises a step of feeding a continuous extruded pipe 21, a step of cutting the continuous extruded pipe 21 into a plurality of pipes 20, each having a first end 22 and a second end 23 and a step of chamfering a portion 24 of the first end 22 of a respective pipe 20.

Alternatively, the method comprises a step for feeding a series of individual pipes intended to be in turn divided into pipes 20 of shorter length.

The chamfering step comprises a step of plastic deformation of the portion 24 of the first end 22 of the pipe 20 using at least one heated processing tool 5.

According to an aspect of the invention, the chamfering step comprises a step of bringing into contact the heated processing tool 5 with the portion 24 of the first end 22 of the pipe 20.

In other words, the chamfering step comprises a step of moving the processing tool 5 radially relative to the pipe 20 from a first non-operating position P1, in which it is not engaged with the pipe 20, and an operating position P2, in which it comes into contact with an outer surface 26 of the portion 24 of the first end 22 of the pipe 20.

The chamfering step comprises a step of bringing into contact a contact element 9 with the portion 24 of the first end 22 of the pipe 20.

In other words, the chamfering step comprises a step of moving the contact element 9 relative to the pipe 20 from a first non-operating position P1, in which it is not engaged with the pipe 20, to an operating position P2, in which it comes into contact with an inner surface 27 of the portion 24 of the first end 22 of the pipe 20.

Preferably, the steps which carry the processing tool 5 and the contact element 9 into contact with the portion 24 of the first end 22 of the pipe 20 are performed in sequence with the contact element 9 in front of the tool 5.

According to an aspect of the invention, the chamfering step comprises a step of relative movement of the heated processing tool 5 relative to the pipe 20, or vice versa.

Preferably, the step of relative movement of the heated processing tool 5 with respect to the pipe 20 comprises a relative rotation of the processing tool 5 about the pipe 20, or vice versa.

More specifically, during the chamfering step, the processing tool 5 is moved in rotation about the pipe 20, or vice versa.

In this way, the chamfering step allows the chamfering for the complete circumference of the portion 24 of the first end 22 of the pipe 20.

According to an embodiment, the step of chamfering the portion 24 of the first end 22 of a respective pipe 20 occurs at the same time as the cutting step.

Basically, according to this embodiment of the method, the portion 24 of the first end 22 of each pipe 20 is then also consequently chamfered without a step of transferring the pipe 20 to a subsequent processing station.

According to an alternative embodiment, the step of chamfering the first end 22 of a respective pipe 20 occurs after the cutting step in a consequent dedicated chamfering station.

According to this alternative embodiment, the method comprises a step of transferring the pipe 20, carried out during the cutting step, to a chamfering station 14 different from the station comprising the cutting unit 3.

More specifically, according to this alternative embodiment of the method, after the cutting step, the portion 24 of the first end 22 of the pipe 20 is consequently also chamfered after a step of transferring the pipe 20 to the chamfering station 14.

According to an aspect of the invention, the method comprises a step of heating the processing tool 5 before and/or during the chamfering step. The step of heating the processing tool 5 is in particular a step of heating a processing surface 6 of the processing tool 5 to a predetermined temperature, preferably between 50° C. and 200° C. as a function of the nature of the thermoplastic material of the pipe.

The step of heating the processing tool 5, and in particular the processing surface 6, facilitates the chamfering by plastic deformation of the pipe 20.

According to an embodiment (especially for pipes with a large wall thickness), the method comprises a step of localised heating of the portion 24 of the first end 22 of the pipe 20 before the chamfering step.

In other words, the method also comprises heating the pipe 20 before it is chamfered during the chamfering step using the heated processing tool 5.

Heating the pipe 20 before it is chamfered using the chamfering tool 5, which is also heated, favours and accelerates the plastic deformation of the pipe 20 without removal of material during the chamfering step.

According to an embodiment, the method comprises a step of belling the second end 23 of the pipe 20 after the step of cutting the continuous extruded pipe 21.

The expression “belling” of the second end 23 of the pipe 20 means a bell-shaped widening of the second end 23 so as to favour the coupling with the first chamfered end 22 of another pipe 20.

1. An apparatus for processing a pipe made of thermoplastic material, comprising:
each pipe extends along a longitudinal axis and has a first end and a second end;
an element for chamfering a portion of the first end of a respective pipe comprising at least one processing tool having a processing surface,
the apparatus being characterised in that it comprises heating means associated with the processing tool configured for heating the processing surface of the processing tool to a predetermined temperature.

2. The apparatus according to claim 1, characterised in that the heating means come into contact with at least part of the processing tool.

3. The apparatus according to claim 1, wherein it comprises a command and control unit and at least one temperature sensor configured for determining a temperature value of the heating means and/or of the processing surface of the processing tool and sending a signal, representing the temperature value, to the command and control unit, the command and control unit is configured for setting the operating temperature of the heating means as a function of said signal.

4. The apparatus according to claim 1, wherein the chamfering element comprises a contact element (9) configured for operating in conjunction with the processing tool; the processing tool and the contact element are configured to pass between a non-operating position, wherein they are not engaged with the pipe, and an operating position, wherein they make contact with a respective surface (26,27) of the portion of the first end of the pipe.

5. The apparatus according to claim 1, wherein it comprises an element for supporting the chamfering element configured for rotating the chamfering element about the axis of the pipe.

6. The apparatus according to claim 5, wherein the supporting unit comprises movement means configured for moving the processing tool radially relative to the pipe from the non-operating position to the operating position and vice versa.

7. The apparatus according to claim 5, wherein the supporting element comprises a cutting unit configured for forming the pipes.

8. The apparatus according to any one of the preceding claims, characterised in that it comprises a station for heating at least the portion of the first end of each pipe positioned upstream of the chamfering element.

9. The apparatus according to claim 1, wherein the processing surface of the pipe does not have cutters and the processing tool has a truncated cone shape having a larger base designed to make contact with the heating means.

10. The apparatus according to claim 1, wherein the cutting tool comprises a knife blade or a circular blade having an axis and configured to rotate about the axis.

11. A method for processing a pipe made of thermoplastic material, in particular PVC-U, which extends along a longitudinal axis and has a first end and a second end;
a step of chamfering a portion of the first end of a respective pipe, the method being characterised in that
the chamfering step comprises a step of plastic deformation of the portion of the first end of the pipe using at least one heated processing tool.

12. The method according to claim 11, wherein the chamfering step comprises a step of bringing into contact the heated processing tool with the portion of the first end of the pipe and a step of relative movement of the heated processing tool with respect to the pipe.

13. The method according to claim 12, wherein the step of relative movement of the heated processing tool with respect to the pipe comprises a relative rotation of the processing tool about the pipe.

14. The method according to claim 11, wherein the step of chamfering the portion of the first end of a respective pipe occurs simultaneously with the step of cutting the continuous extruded pipe at the first end.

15. The method according to claim 11, wherein the step of chamfering the portion of the first end of a respective pipe occurs after the step of cutting the continuous extruded pipe at the first end.

16. The method according to claim 12, wherein it comprises a step of heating the processing tool before and/or during the chamfering step.

17. The method according to claim 13, wherein it comprises a step of localised heating of the portion of the first end of the pipe before the chamfering step.
